(19) United States
(12) Patent Application Publication
(10) Pub. No.: US 2016/0298998 A1
(43) Pub. Date: Oct. 13, 2016

(54) Electronic Oil Level Gauge

(71) Applicant: Lin Yang, Lynnfield, MA (US)

(72) Inventor: Lin Yang, Lynnfield, MA (US)

(21) Appl. No.: 15/086,676

(22) Filed: Mar. 31, 2016

Related U.S. Application Data
(60) Provisional application No. 62/145,602, filed on Apr. 10, 2015.

(51) Int. Cl. G01F 23/38

(52) U.S. Cl. CPC G01F 23/38

(57) ABSTRACT

Methods and systems for converting mechanical oil gauge into an electronic oil gauge. A magnet pairing mechanism and a resistive sensing module are configured to amount to a mechanical oil gauge. The indicator of the mechanical oil gauge moves with the first magnet which cause the second magnet to move on the resistive sensing module which results in changing the resistance of the resistive sensing module at the sliding-to-position, producing an electric signal that is corresponding to the oil level.

### CROSS-REFERENCE

Priority is claimed from the U.S. Provisional Patent Application No. 62/145602 filed on Apr. 10, 2015, which is hereby incorporated by reference.

### DESCRIPTION OF RELATED ART

The present application relates to an oil level gauge, and more particularly to an oil level gauge having two-piece magnet mechanism to measure oil level electronically.

Note that the points discussed below may reflect the hindsight gained from the disclosed inventions, and are not necessarily admitted to be prior art.

Oil level gauges have been used to monitor oil levels in oil tanks and containers such as those used for household heating oils. However, mechanical oil gauges require users to visit and check onsite. An electronic oil gauge can provide electronic oil level signal that can be used for remote measurement through wire and wireless transmission or for oil level control and monitor systems.

### SUMMARY

The present application discloses a novel electronic oil level gauge design or an oil gauge add-on device that converts the position of the indicator in mechanical oil gauge into electronic signal.

In one embodiment, a magnetic position sensor device includes a first and second magnet pieces and a sliding track on a resistive sensing module disposed on the track where first magnet that travels with oil level attracts the second magnet piece to slide on the resistive sensing module, causing a resistance change in the resistive sensing module.

In one aspect of an embodiment, the resistive sensing module comprises an exposed resistor ladder on a printed circuit board (PCB). In another aspect of an embodiment, the resistive sensing module comprises a commercially available resistive slide potentiometer, such as SOFTPOT from Spectra Symbol Inc.

In one embodiment, a traditional commercially available KING LEAK PROOF oil tank gauge having an upper body oil level indicator and lower float device is converted to an electronic oil gauge wherein a magnet piece is mounted on the top of the indicator of the oil gauge and an add-on device is configured to hold onto the outer housing of the gauge. The add-on device includes a sliding track, a resistive sensing module, a magnet piece to move along the track, and an electronic circuit board. The movement of the first magnet piece on the oil indicator attracts the second magnet piece to move and press on the resistive sensing module on the track, resulting in the resistance change in the resistive sensing module. The resistance of the resistive sensing module can be measured by the electronic circuit board.

In another embodiment, an electronic oil level gauge is configured as a rectangular or ono-circular tubular housing, which houses a resistive sensing module, a magnet piece and an electronic circuit board. The tubular housing is placed into a float with a center hole fitting to the tubular housing to allow the float freely travel along with the tubular housing but prevent the float from turning around the housing. At the float one magnet piece is placed close to the side of the housing wall that is adjacent to the resistive sensing module in the tubular housing. Another none-magnetic metal piece is placed at the other side of the float to keep the float balance. The magnet piece at the float moving with oil level attracts another magnet piece in the tubular housing to move and press on the resistive sensing module, resulting in the resistance change in the module. The resistance of the resistive sensing module can be measured by the electronic circuit board.

The disclosed innovation provides an easy tool set to convert a traditional oil gauge into an electronic oil gauge to provide electronic oil level signal.

### BRIEF DESCRIPTION OF THE DRAWINGS

The disclosed application will be described with reference to the accompanying drawings, which show important sample embodiments of the invention which are incorporated in the specification hereof by reference, wherein:

FIG. 1 shows a prospective view of an example mechanical oil tank gauge wherein a magnet piece is attached on the top of the indicator in accordance with this application.

FIG. 2 shows a prospective view of an example oil-gauge add-on device that converts the mechanical reading of the oil tank gauge of FIG. 1 into electronic signal in accordance with this application.

FIG. 3A shows an expanded view of a mechanical oil tank gauge of FIG. 1 to be assembled with the oil-gauge add-on device of FIG. 2.

FIG. 3B shows a prospective view of the assembled device of FIG. 3A.

FIG. 3C shows a sectional view of the assembled device of FIG. 3B.

FIG. 4 shows an example electric circuit structure of the printed circuit board as resistive sensing module in FIG. 2 in accordance with this application.

FIG. 5 shows another example electric circuit structure of the printed circuit board as resistive sensing module in FIG. 2 in accordance with this application.

FIG. 6 shows another example oil level gauge design assembly in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The term “oil level gauge” generally refers to that mechanical vertically mountable oil gauge for being installed on an oil tank, such as household tank for heating oil. Other applications are also intended and included as an ordinary person in the art can make obvious modifications to make the device suitable for various situations.

The disclosed oil gauge design can be made with any suitable materials, for example, plastic, metal and carbon fiber polymer and glass materials. For clarity reasons, the given examples described are made in glass or plastic.

The term “resistive sensing module” in this application refers to either a plurality of resistors which electric contacts linearly arranged and positioned in a geometric way on a printed circuit board (PCB) or a flat membrane potentiometer device. In the case using a PCB board, the total electric resistance is a function of the length of the electric circuit along its elongated axis, the total resistance after short-circuiting two adjacent resistor contacts reflects the position on said resistive sensing module. In the case using a membrane potentiometer device as the resistive sensing module, the resistance reading of the device is determined by the location of the magnet piece pressed on the resistive sensing module. The magnet piece is attracted by another magnet piece that travels with oil level float. An example of the membrane potentiometers is SOFTPOT membrane potentiometer device made by Spectra Symbol company as it is described at http ://www. spectrasymbol.com/potentiometer/softpot/how-it-works-softpot.

The term “sliding-to-position” refers to a position on the resistive sensing module that the magnet in the disclosed device moves and presses on the membrane potentiometer or that short-circuits the two adjacent resistor contacts on the PCB board.

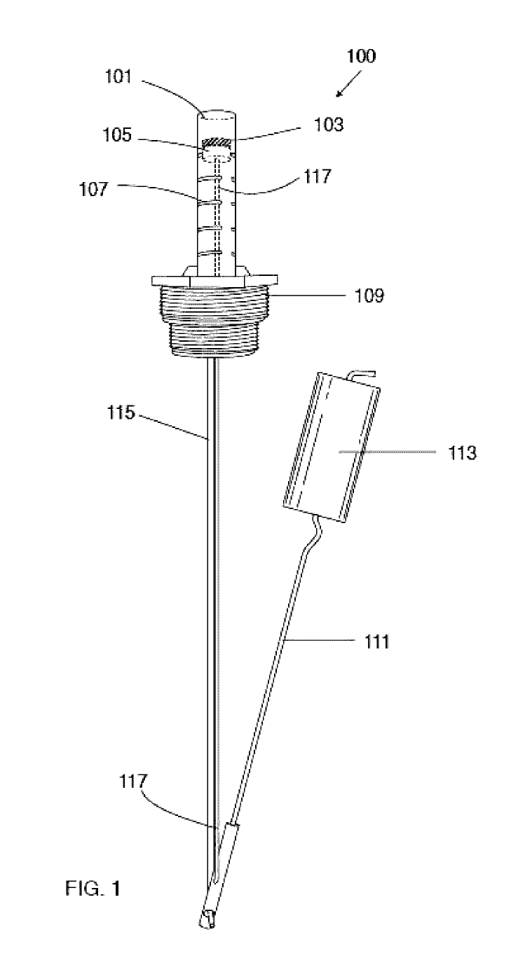

In reference to FIG. 1, a typical vertically mountable KING LEAK PROOF oil tank gauge 100 includes a float portion 113, a lever arm 111, an elongated support arm 115, a mounting screw set 109, an indicator piece 105, a lever flange 117 and a cylindrical and transparent tubular pipe structure 101 for housing indicator piece 105 and measure marks 107. Level arm 111 holds float portion 113 where lever arm 111 is mounted to bottom end of lever flange 117 which is in turn amounted on support arm 115. In use, the elongated support arm 115 will be placed into an oil tank and float portion 113 will be floating on the surface of oil contained in the tank. Together both with the length of lever arm 111 and the length of lever flange 117, float portion 113 will be able to reach to the bottom of the oil tank when oil level is low to the bottom.

The upper end of lever flange 117 is mounted to indicator piece 105 and is protected by the transparent pipe housing 101 for shield and level marks to read oil measures. When the oil level is high, float portion 113 will float upwards, dragging lever arm 111 and lever flange 117 to move upwards and indicator 105 on the other end of flange 117 will thus move towards the top of housing 101 to indicate that oil level is high. When the oil level is lower, float portion 113 will float downwards, dragging lever arm 111 and lever flange 117 to move downwards, indicator 105 on the end of flange 117 will then move towards the bottom of housing 101 to indicate that oil level is lower. To covert a vertically mountable mechanical KING LEAK PROOF oil tank gauge into electronic oil gauge, a magnet piece 103 is mounted onto the top surface of indicator piece 105, so that as indicator 105 moves with the magnet piece 103 together.

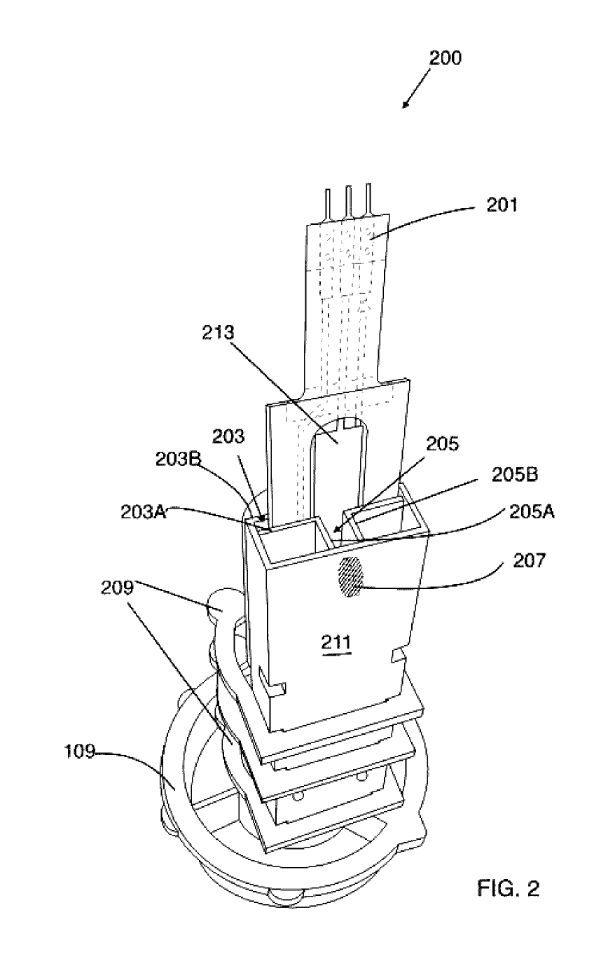

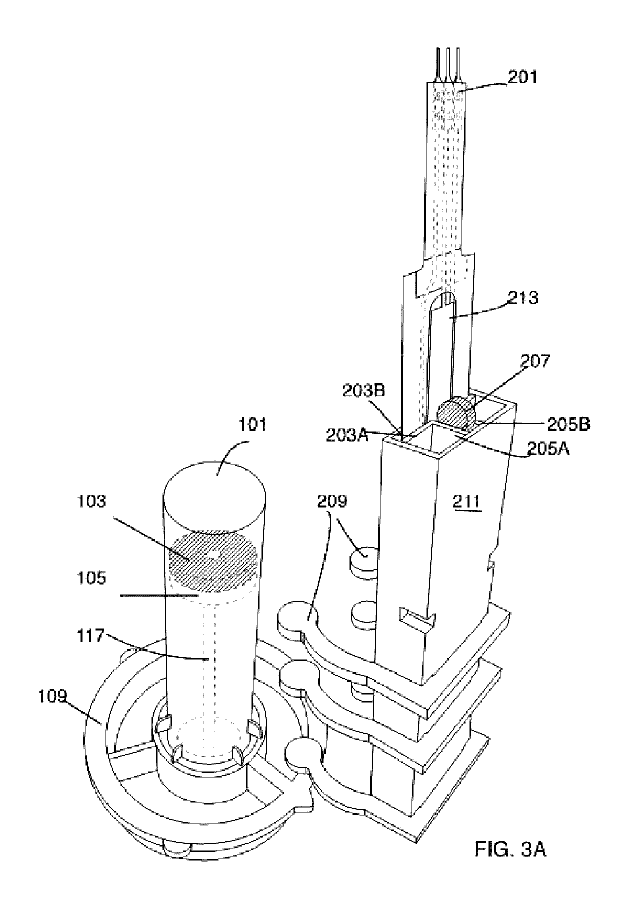

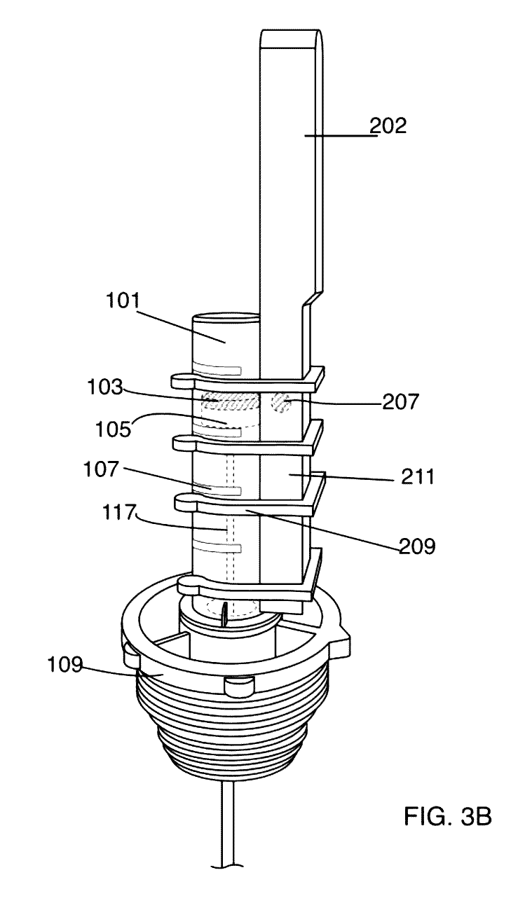

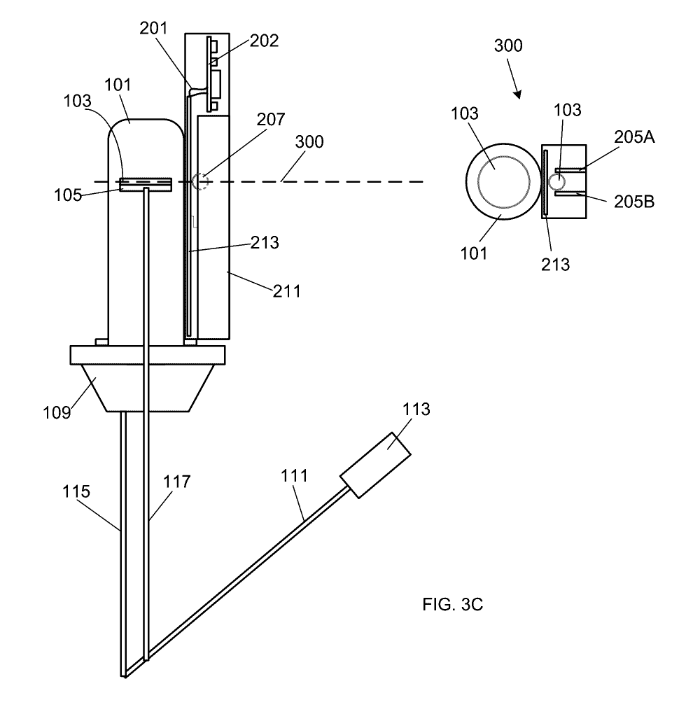

In reference to FIG. 2, FIG. 3A, 3B, and 3C, oil gauge add-on device 200 is disclosed to covert the mechanical positional changes of magnet piece 103 into electronic signal. Device 200 includes an elongated housing body 211 having a clamping section 203 that mounts with an elongated resistive sensing module 213 between the section walls 203A and 203B, a sliding track section 205 is configured within housing body 211 with two walls 205A and 205B to form a sliding track for the resistive sensing module 213. In between the sliding track walls 205A and 205B, a magnet piece 207 is disposed within the track to slide up and down. Surrounding housing body 211 are configured a set of clamping arms 209 that can tightly clamp onto the cylindrical and transparent tubular pipe structure 101. As shown in the sectional view of FIG. 3C, the upper reading tube 101 of oil gauge 100 is tightly clamped onto add-on device 200 so that resistive sensing module 213 tangibly clings to the exterior surface of the wall of the reading tube 101. When indicator piece 105 moves by the oil level, magnet piece 103 will move accordingly, and magnet piece 207 will be attracted by the magnet 103 to slide on circuit module 213 within the track formed by track walls 205A and 205B. Magnet piece 207 will cause resistance change in the circuit module 213 at the sliding-to-position, generating resistance reading accordingly

The resistive sensing module 213 is connected with resistance measuring leads 201 that can be measured by electronic circuit board 202.

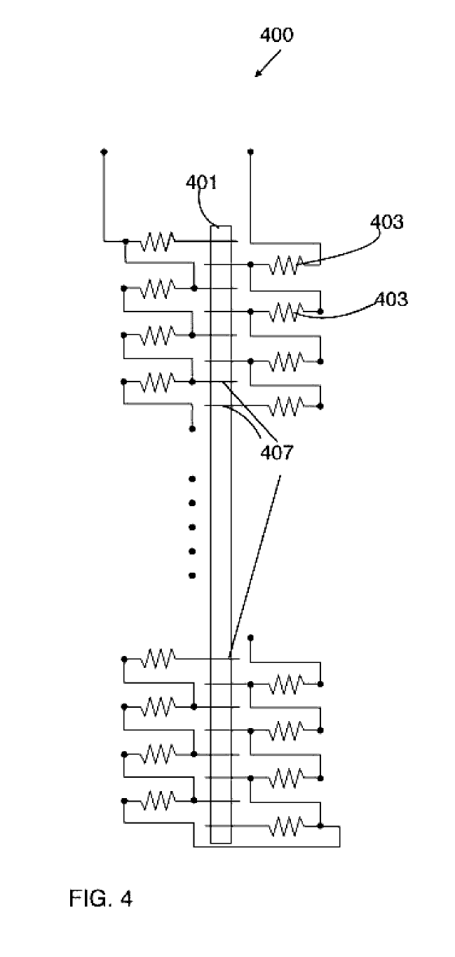

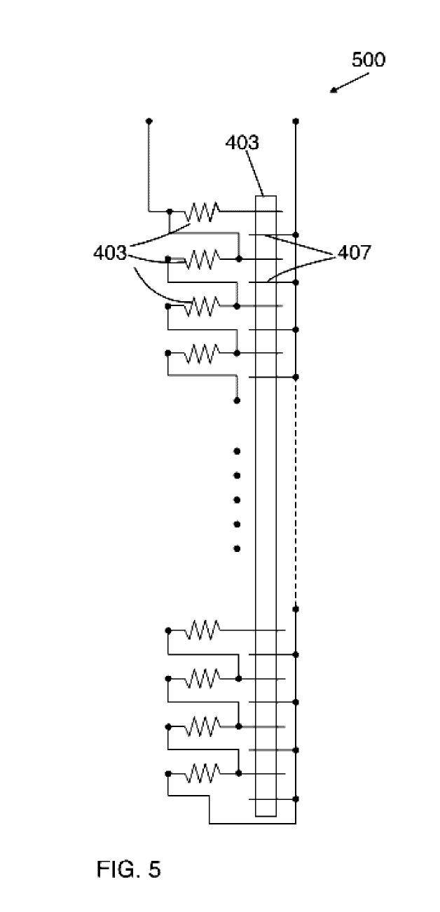

In reference to FIG. 4 and FIG. 5, example circuit modules 400 and 500 are shown. Such circuit modules are configured to comprise a series of resisters 403 and the contacts 407 of the resistors are arranged in a geometrically ladder form along the elongation axis 401 of the panel. As magnet 207 slides along axis 401, the contacts 407 are short-circuited, generating resistance reading in accordance with the sliding position.

Alternatively, a commercial membrane potentiometer device, such as SOFTPOT from Spectra Symbol company can be placed on the sliding track for magnet piece to slide on. With its sensitivity to pressure, SOFTPOT membrane potentiometer can sense the location of the applied magnet piece, generating a resistance reading in accordance with the sliding position.

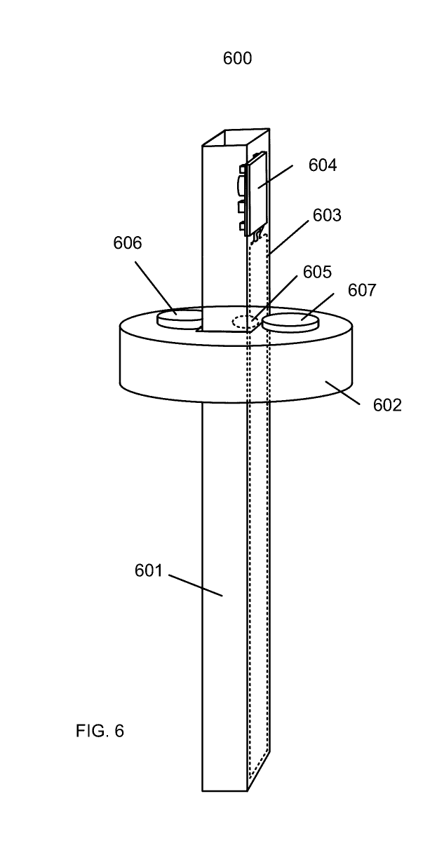

In reference to FIG. 6, an alternative oil gauge 600 is described. Instead of converting the traditional oil tank gauge, the alternative oil gauge 600 directly uses the two-piece magnet mechanism to measure oil levels in a container. Oil gauge 600 is configured to comprise a rectangular tubular housing 601 and a float 602. The tubular housing 601 contains a resistive sensing module 603 and a magnet piece 605. A magnet 611 and a none-magnetic balance metal piece 606 are attached to the float 602. Tubular housing 601 is sealed to protect the piece 605, the resistive sensing module 603, and electronic circuit board 604. The magnet piece 607 at the float 602 is in interaction through magnetic field with magnet piece 605, attracting it to move up or down with the float 602. The movement of magnet piece 605 on resistive sensing module 603 will cause the resistance change on the resistive sensing module 603, generating resistance reading that is measured by the electronic circuit board 604 for wired or wireless data transmission.

As will be recognized by those skilled in the art, the innovative concepts described in the present application can be modified and varied over a range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. An oil gauge add-on converter that converts the position of the indicator in oil gauge into electronic signal with two-piece magnet mechanism.
An add-on electronic converter comprising:
a first magnet piece to be mounted onto said indicator in use so that said first magnet piece moves together with said indicator;
a second magnet piece is configured to slide on a resistive sensing module. an electronic circuit board that measures the resistance of said resistive sensing module.
a housing body that houses said resistive sensing module, said second magnet piece, and said electronic circuit board. In use said housing body is placed in adjacent to said indicator outside of said mechanical oil gauge.
said first magnet piece travels with said indicator and attracts said second magnet piece to press onto said resistive sensing module resulting in resistance change that can be measured by electronic circuit board.

2. The add-on electronic converter for mechanical oil gauge of claim 1, wherein said resistive sensing module is membrane potentiometer device, such as SOFTPOT made by Spectra Symbol.

3. The add-on electronic converter for mechanical oil gauge of claim 1, wherein said resistive sensing module is alternatively resistor ladder linearly connected and exposed wire contacts on a printed circuit board. said second magnet piece slides on said exposed wire contacts causes resistance change corresponding to oil level.

5. The add-on electronic converter for mechanical oil gauge of claim 1, said electronic circuit board measures resistance of said resistive sensing module and converts to oil level signal.

6. A method for providing electronic oil level tubular gauge comprising,
a float with a center rectangular or none-circular hole.
a first magnet piece to be mounted onto one side of said float and a none magnetic metal piece is mounted at opposite side of said float to balance said float.
a tubular housing fits into said float center hole such that in use said float can freely travel along said tubular housing with oil level.
said tubular housing houses a resistive sensing module, a second magnet piece attracted by said first magnet piece and an electronic circuit board.
said first magnet on said float traveling with oil level along said tubular housing attracts said second magnet piece inside said tubular housing to move and press on said resistive sensing module resulting in resistance change in said sensing module.
said resistance change is measured by an electronic circuit board in said tubular housing.

7. The method of claim 6, wherein said tubular housing body and said float center hole are rectangular or non-circular to prevent said float from turning around said tubular housing.

8. The method of claim 6 wherein said first magnet is placed adjacent to the wall of said tubular housing where on inside of said wall said resistive sensing module is placed.
